(19) United States
(12) Patent Application Publication
(10) Pub. No.: US 2008/0062961 A1
(43) Pub. Date: Mar. 13, 2008

(54) METHOD AND SYSTEM FOR MANAGING COMMUNICATION SESSIONS IN A PLURALITY OF COMMUNICATION NETWORKS

(75) Inventor: Steven J. Nowlan, South Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/466,996

(22) Filed: Aug. 24, 2006

(51) Int. Cl. H04L 12/66

(52) U.S. Cl. 370/352

(57) ABSTRACT

A method for managing one or more communication sessions in a plurality of networks is provided. The plurality of networks includes one or more mobile telephone networks and one or more IP-based wireless communication networks. The method includes accessing (304) a mobile telephone network (104) by an electronic device (102). The service from the mobile telephone network is provided by a first service provider. Further, the method includes detecting (306) an IP-based wireless communication network (106). The service from the IP-based wireless communication network is provided by a second service provider. Moreover, the method includes establishing an automatic rerouting (308) of communication sessions for the electronic device from the mobile telephone network to the IP-based wireless communication network. The re-routing is established such that new communication sessions will be automatically routed to the IP-based wireless communication network.

The present invention generally relates to communication networks, and more particularly, to management of communication in the plurality of communication networks.

### BACKGROUND OF THE INVENTION

In recent years, the need for communication and information exchange has increased tremendously. This has resulted in an increase in the utility of communication networks, which enable users to communicate and exchange information amongst them. Examples of a communication network include an Advanced Mobile Phone System (AMPS) network, a Global System for Mobile Communications (GSM) network, a Universal Mobile Telecommunication System (UMTS) network, and a Digital Cellular System (DCS) network, a Local Area Network (LAN) and a Wireless Fidelity (WiFi) network.

The cost incurred by the users to communicate through different communication networks can vary. In some cases, such as in a UMTS network and a WiFi network, the cost difference could be substantial. Further, some networks can provide a better data transmission rate or a Quality of Services (QoS) than that provided by other networks.

In the current available method, a user is allowed to switch from one type of communication network to another, for example, between a mobile communication network and a WiFi network. However, the method suffers from the following limitations. First, the method requires maintenance of two separate identities, one in each network. This enables a user to access only one type of network at a time, for example, either the mobile communication network or the WiFi network. Therefore, the user may not be able to receive communication in one communication network, when the user is accessing another communication network. Second, the method requires manual switching between the networks, causing inconvenience to the user.

In view of the foregoing discussion, there exists need for a method and system that allows a user to switch automatically from one type of communication network to another, such as between a mobile communication network and a WiFi network. Further, the method and system should enable the user to receive communication from a plurality of communication networks simultaneously. For example, a user should be able to receive a call in a mobile telephone network even when the user is accessing a WiFi network. Moreover, the method and system should eliminate the need for manual switching between the networks.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments as well as explain various principles and advantages, all in accordance with the present invention.

FIG. 1 illustrates an exemplary environment, where various embodiments of the present invention can be practiced;

FIG. 2 illustrates a block diagram of an electronic device, in accordance with an embodiment of the present invention;

FIG. 3 is a flow diagram illustrating a method for managing communication sessions in a plurality of communication networks, in accordance with an embodiment of the present invention; and

FIGS. 4 and 5 is a flow diagram illustrating a method for managing communication sessions in a plurality of communication networks, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of embodiments of the present invention.

### DETAILED DESCRIPTION

Before describing in detail the particular method and system for communicating in a communication network, in accordance with various embodiments of the present invention, it should be observed that the present invention resides primarily in combinations of method steps related to assigning priority to a talk group in a communication network. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements not expressly listed or inherent to such a process, method, article or apparatus. An element proceeded by “comprises . . . a” does not, without more constraints, preclude the existence of additional identical elements in the process, method, article or apparatus that comprises the element.

A “set”, as used in this document, means a non-empty set, i.e., comprising at least one member. The term “another,” as used in this document, is defined as at least a second or more. The terms “includes” and/or “having”, as used herein, are defined as comprising.

In an embodiment, a method for managing communication sessions in a plurality of networks is provided. The plurality of networks includes one or more mobile telephone networks and one or more Internet Protocol (IP) based wireless communication networks. The method includes accessing a mobile telephone network by an electronic device. The service from the mobile telephone network is provided by a first service provider. Further, the method includes detecting an IP based wireless communication network by the electronic device. The service from the IP-based wireless communication network is provided by a second service provider. Moreover, the method includes automatically rerouting communication sessions from the mobile telephone network to the IP-based wireless communication network. Any new communication sessions established on the mobile telephone network, and which are to be terminated at the electronic device, are automatically routed to the IP-based wireless communication network.

An electronic device is provided, in accordance with the present invention. The electronic device includes a first modem that can access a mobile telephone network. The service from the mobile telephone network is provided by a first service provider. The electronic device also includes a second modem that can access an IP-based wireless communication network. The service from the IP-based wireless communication network is provided by a second service provider. Moreover, the electronic device includes a processor that can configure automatic re-routing of a communication session from the mobile network to the IP-based wireless communication network. The new communication sessions, which are to be terminated at the electronic device and are established on the mobile network, are automatically routed to the IP-based wireless communication network.

It should be noted that the invention is described with reference to a mobile telephone network and an IP-based wireless communication network for the sake of clarity, however it will be understood by a person ordinarily skilled in the art that the invention can be implemented for any other type of communication networks as well.

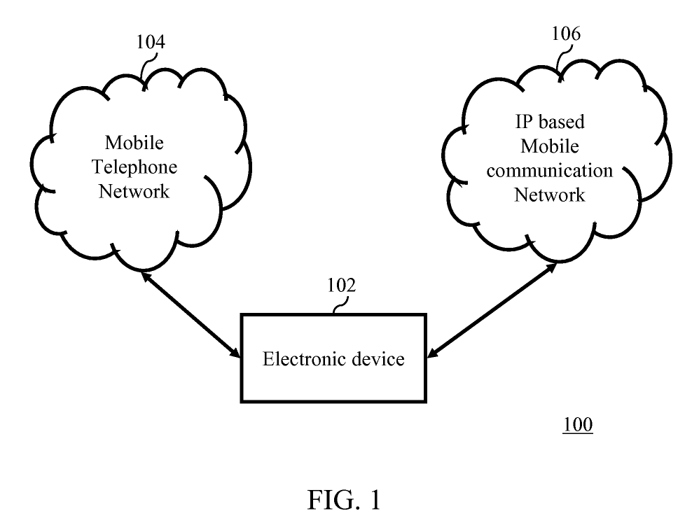

FIG. 1 illustrates an exemplary environment, where various embodiments of the present invention can be practiced. The environment 100 includes an electronic device 102, a mobile telephone network 104, and an IP-based wireless communication network 106. Examples of the mobile telephone network 104 include, but are not limited to, a Global System for Mobile Communications (GSM) network, and a Code Division Multiple Access (CDMA) network. Examples of the IP-based wireless communication network 106 include, but are not limited to, a Universal Mobile Telecommunication System (UMTS) network, a Digital Cellular Systems (DCS) network, and a (Wireless Fidelity)WiFi network. The electronic device 102 can communicate with other electronic devices in the mobile telephone network 104, or the IP-based wireless communication network 106. It should be noted that the cost of communication, paid by a user, is generally less in the IP-based wireless communication network 106 than that in the mobile telephone network 104. However, it will be understood by a person ordinarily skilled in the art that the cost of communication does not effect the invention in any way. Examples of a communication device include, but are not limited to, a cell phone, a Personal Digital Assistant (PDA), a smart phone, and a laptop.

In FIG. 1, the mobile telephone network 104 and the IP-based wireless communication network 106 are shown for the sake of clarity only and in no way limit the invention. Further, it should be noted that FIG. 1 can include a plurality of each type of communication network and/or any other types of communication networks as well.

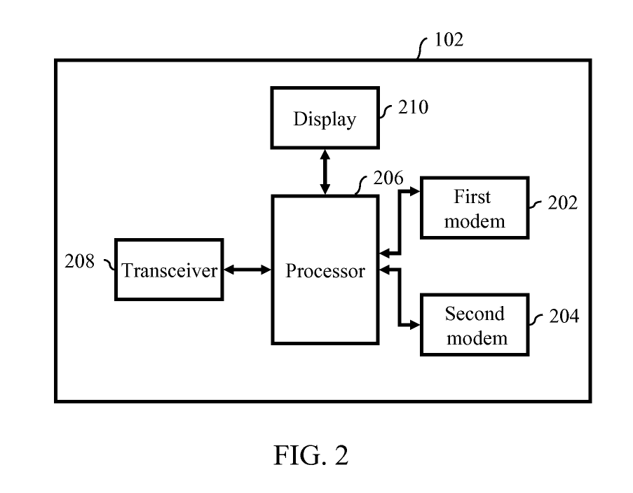

FIG. 2 illustrates a block diagram of an electronic device 102, in accordance with various embodiments of the present invention. The electronic device 102 includes a first modem 202, a second modem 204, and a processor 206. The first modem 202 can access the mobile telephone network 104. The first modem 202 enables the electronic device 102 to communicate with other electronic devices in the mobile telephone network 104. The service from the mobile telephone network 104 is provided by a first service provider. A service provider can be a telecommunications company, a data carrier company, a wireless communication provider, an Internet Service Provider, or a cable television operator. In an embodiment, the first modem 202 gets activated when the IP-based wireless communication network 106 is substantially inaccessible and the mobile telephone network 104 is detected. For example, the first modem 202 activates when the coverage of a Wi-Fi network is unavailable and the coverage of a UMTS network is available. In another embodiment, the first modem 202 gets deactivated when the IP-based wireless communication network 106 is detected. In an embodiment, the first modem 202 may not require manual intervention to activate or deactivate. In other words, the user of the electronic device 102 may not be even aware of activation or deactivation of the first modem 202.

The second modem 204, in the electronic device 102, can access the IP-based wireless communication network 106. The second modem 204 enables the electronic device 102 to communicate in the IP-based wireless communication network 106, the service to which is provided by a second service provider. In an embodiment, the second modem 204 activates when the IP-based wireless communication network 106 is detected. In an embodiment, the second modem 204 remains activated as long as a preceding communication session remains established in the IP-based wireless communication network 106. In an embodiment, the second modem 204 deactivates if the IP-based wireless communication network 106 is substantially inaccessible. For example, the second modem 204 deactivates if the coverage of a WiFi network is unavailable.

Moreover, the processor 206 in the electronic device 102 can be configured to automatically reroute a communication session in the mobile telephone network 104 to the IP-based wireless communication network 106. Thereafter, new communication sessions, which are to be terminated at the electronic device 102 and are established in the mobile telephone network 104, are automatically routed to the IP-based wireless communication network 106. For example, when a mobile phone switches from a UMTS network to a WiFi network, the calls for the mobile phone in the UMTS network are automatically forwarded to the WiFi network. This automatic forwarding may not require manual intervention. Further, the user may not be informed about the forwarding of the calls.

In an embodiment, the electronic device 102 also includes a transceiver 208 and a display 210. The transceiver 208 can detect the mobile telephone network 104 and the IP-based wireless communication network 106. Further, the display 210 can indicate to the electronic device 102, when the mobile telephone network 104 and/or the IP-based wireless communication network 106 is detected.

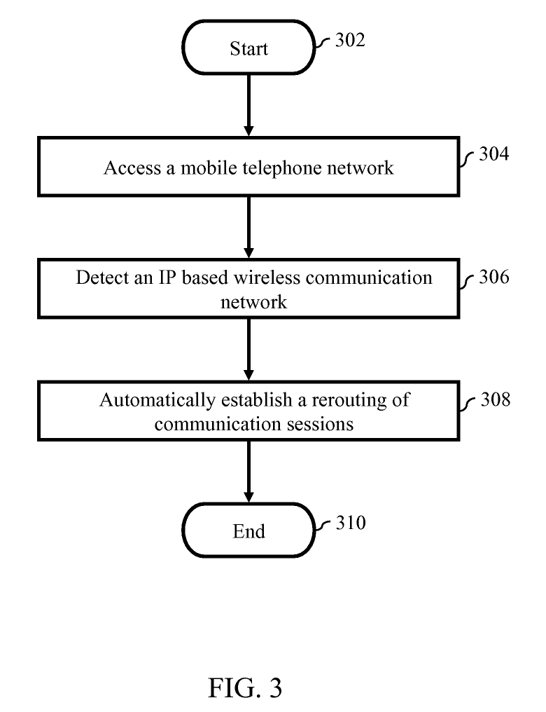

FIG. 3 is a flow diagram illustrating a method for managing communication sessions in the plurality of communication networks, in accordance with various embodiments of the present invention. The method starts at step 302. At step 304, the mobile telephone network 104 is accessed by the electronic device 102. The mobile telephone network 104 is provided by a first service provider. At step 306, the IP-based wireless communication network 106 is detected by the electronic device 102. The service from the IP-based wireless communication network 106 is provided by a second service provider. In an embodiment, the electronic device 102 indicates the user of the electronic device 102 when the IP-based wireless communication network 106 is detected. The indication can be in form of sound signal, light signal, a beep, a message, a vibration, and so forth.

At step 308, a rerouting of communication sessions for the electronic device 102 is automatically established from the mobile telephone network 104 to the IP-based wireless communication network 106. In other words, forwarding of calls from the mobile telephone network 104 to the IP-based wireless communication network 106 is automatically configured without any manual intervention, as soon as the IP-based wireless communication network 106 is detected. Further, the new communication sessions established at the mobile telephone network 104 that are to be terminated at the electronic device 102 will be automatically routed to the IP-based wireless communication network 106. Once the electronic device 102 starts accessing the IP-based wireless communication network 106, all the subsequent communications (or calls) in the mobile telephone network 104 will be automatically forwarded in the IP-based wireless communication network 106. In an embodiment, the automatic establishment of the rerouting is performed in response to the detection of the IP-based wireless communication network 106. An indication can be made to the user when the rerouting is acknowledged. Further, the user can switch to the IP-based wireless communication network 106 based on the indication. The establishment of the rerouting can be performed in response to the user action. For example, the user can choose either to automatically forward all (or some specific) subsequent calls in a WiFi network or may disable the forwarding of calls to the WiFi network. Thereafter, the process terminates at step 310.

In an embodiment, a request is sent to the mobile telephone network 104 by the electronic device 102 to reroute the communication sessions that are to be terminated at the electronic device 102. The rerouting is performed by using an identifier of the electronic device 102 associated with the IP-based wireless communication network 106. An example of the identifier of the electronic device 102 can be the IP address of the electronic device 102. It should be noted that the electronic device 102 can have separate identities in the mobile telephone network 104 and the IP-based wireless communication network 106. For example, the electronic device 102 can have a Subscriber Identity Module (SIM) number in a mobile network and an IP address in a WiFi network. It should also be noted that a SIM number is often permanently associated with a device, while an IP address is dynamic and may change across IP sessions. Further, the electronic device 102 can receive an acknowledgment of the re-route request.

In another embodiment, the automatic establishment of the rerouting of communication is delayed until an active communication session ends. In such an event, the automatic establishment of the rerouting of communication sessions is delayed even if the IP-based wireless communication network 106 is detected during the active communication session. The subsequent communication sessions are established in the IP-based wireless communication network 106.

In an embodiment, when an imminent loss of service from the IP-based wireless communication network 106 is detected, the rerouting of communication sessions for the electronic device 102 from the mobile telephone network 104 to the IP-based wireless communication network 106 is canceled automatically. For example, the coverage of a WiFi network is unavailable when automatic call forwarding is canceled automatically.

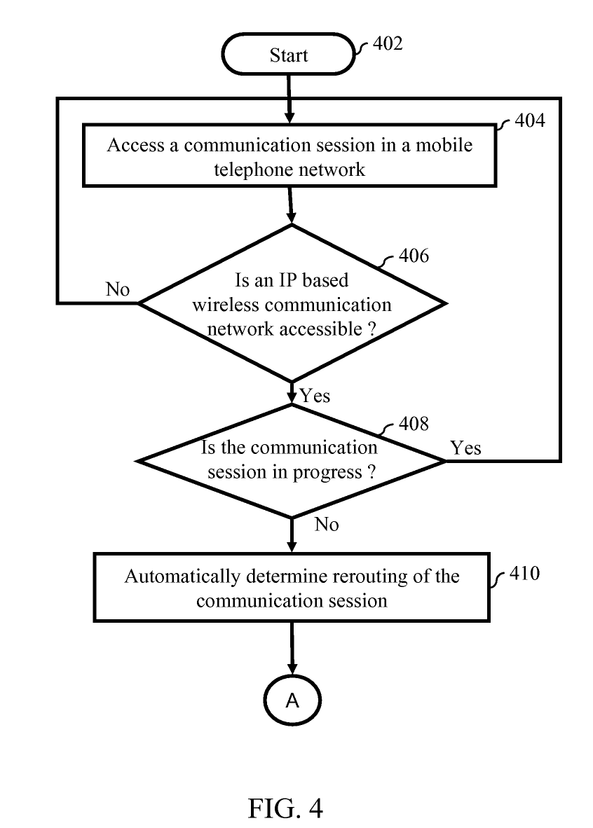

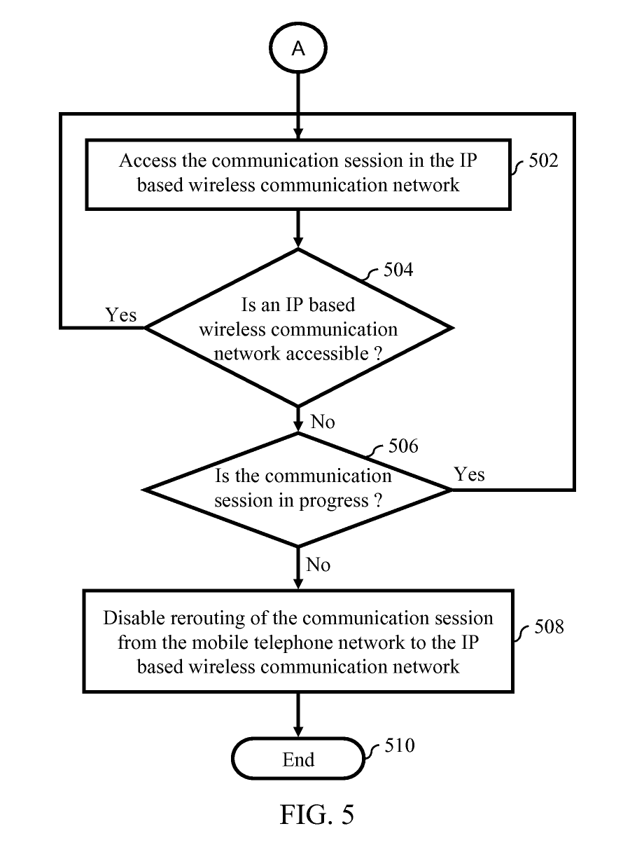

FIG. 4 and 5 is a flow diagram illustrating a method for managing communication sessions in the plurality of communication networks, in accordance with another embodiment of the present invention. After initiating the process at step 402, the electronic device 102 accesses the mobile telephone network 104 at step 404. In an embodiment, the electronic device 102 accesses the mobile telephone network 104 by using a first identifier. The first identifier identifies the electronic device 102 in the mobile telephone network 104. For example, the first identifier can be a SIM number.

At step 406, it is determined whether an IP-based wireless communication network 106 is accessible. If it is determined, at step 406, that the IP-based wireless communication network 106 is inaccessible, then, step 404 is performed again. If it is determined at step 406 that the IP-based wireless communication network 106 is accessible, then, step 408 is performed.

At step 408 it is determined whether a communication session is in progress. If it is determined at step 408 that the communication session is in progress, then step 404 is performed. If it is determined at step 408 that the communication session is not in progress, then, step 410 is preformed.

Thereafter, the communication session is automatically rerouted from the mobile telephone network 104 to the IP-based wireless communication network 106, at step 410. In an embodiment, the rerouting from mobile telephone network 104 to the IP-based wireless communication network 106 is based on the user's choice. In other words, as soon as the electronic device 102 detects the IP-based wireless communication network 106, the user receives an indication on the electronic device 102. The user can choose to forward communication sessions to the IP-based wireless communication network 106 based on the indication.

The rerouting from mobile telephone network 104 to the IP-based wireless communication network 106 can be performed without requiring a user's action. The user's action can be acknowledged by displaying a message on the screen of the electronic device 102 after rerouting.

At step 502, the electronic device 102 accesses the IP-based wireless communication network 106 by using a second identifier. The second identifier identifies the electronic device 102 in the IP-based wireless communication network 106.

It is determined, at step 504, whether the IP-based wireless communication network 106 is still accessible. If the IP-based wireless communication network 106 is accessible, then step 502 is performed again. However, if it is determined that the IP-based wireless communication network 106 is not accessible, step 506 is performed.

At step 506, it is determined whether the communication session is in progress (or active). If it is determined that the communication session is in progress (or active), then step 502 is performed again. If it is determined that the communication session is not in progress, then step 508 is performed. At step 508, the automatic rerouting of the communication session from the mobile telephone network 104 to the IP-based wireless communication network 106 is disabled. The subsequent communication sessions are progressed by using the mobile telephone network 104. Thereafter the process terminates at step 510.

The method given above can be explained by taking an example of an electronic device in which an automatic switching feature of the present invention is enabled. Consider that the electronic device 102 is communicating with another electronic device through a mobile telephone network 104. During the communication, the electronic device 102 enters a WiFi hot spot. WiFi hot spots are locations with public access points. Using these access points, the electronic devices can be connected to the Internet by using a Wi-Fi technology. Therefore, the electronic device 102 is switched over from using the mobile telephone network 104 to the IP-based wireless communication network 106.

Various embodiments of the method and system for managing communication in the plurality of communication networks have been described above. Various embodiments of the present invention have significant advantages over the methods and systems that existed in the prior art. When an electronic device moves from a mobile telephone network to an IP-based wireless communication network, the electronic device can be automatically switched from the mobile telephone network to the IP-based wireless communication network. Further, the invention eliminates the need for manual switching between the networks. Moreover, the invention enables users to maintain a single identity to establish communication in either of the networks. Furthermore, the invention enables the user to receive communication in one network even when the user is accessing other network.

It will be appreciated that the method and system for communicating within a wireless communication system described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method to manage communication sessions in a plurality of communication networks. Alternatively, some or all the functions could be implemented by a state machine that has no stored program instructions, or in one or more application-specific integrated circuits (ASICs), in which each function or some combinations of certain of the functions are implemented as custom logic. Of course, a combination of the two approaches could be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims as issued.

What is claimed is:

1. A method for managing one or more communication sessions in a plurality of networks, the plurality of networks comprising one or more mobile telephone networks and one or more Internet Protocol (IP) based wireless communication networks, the method comprising:
accessing a mobile telephone network of the one or more mobile telephone networks by an electronic device, wherein service from the mobile telephone network is provided by a first service provider;
detecting an IP-based wireless communication network of the one or more IP-based wireless communication networks by the electronic device, wherein service from the IP-based wireless communication network is provided by a second service provider; and
automatically establishing a rerouting of communication sessions for the electronic device from the mobile telephone network to the IP-based wireless communication network such that new communication sessions established on the mobile telephone network that are for termination at the electronic device will be automatically routed to the IP-based wireless communication network.

2. The method as recited in claim 1 further comprising presenting a user an indication by the electronic device when the IP-based wireless communication network is detected.

3. The method as recited in claim 2, wherein the automatic establishment of the rerouting is performed in response to the detection of the IP-based wireless communication network, without requiring an intervening user action, and the presentation of the user indication is made after the rerouting is acknowledged.

4. The method as recited in claim 2 further comprising presenting the user, an indication in response to the detection of the IP-based wireless communication network, wherein the automatic establishment of the rerouting is performed in response to a user action.

5. The method as recited in claim 1, wherein automatically establishing the rerouting comprises:
sending a request to the mobile telephone network to reroute communication sessions that are for termination at the electronic device using an identifier of the electronic device associated with the IP-based wireless communication network; and
receiving an acknowledgment of the re-route request.

6. The method as recited in claim 1, wherein automatically establishing the rerouting of communication sessions for the electronic device in one of the one or more mobile telephone networks is delayed until an end of the communication session being in process when the one of the one or more IP wireless networks is detected during the in-process communication session.

7. The method as recited in claim 1 further comprising:
detecting an imminent loss of service from the one of the one or more IP-based wireless communication networks; and
automatically canceling the rerouting of communication sessions for the electronic device from the mobile telephone network to the IP-based wireless communication network in response to the detection of the imminent loss of service.

8. The method as recited in claim 7 further comprising presenting a user indication by the electronic device after the rerouting is automatically cancelled, wherein the indication is a message displayed on the electronic device.

9. An electronic device comprising:
a first modem that can access a mobile telephone network, wherein service from the mobile telephone network is provided by a first service provider;
a second modem that can access an IP-based wireless communication network, wherein service from the IP-based wireless communication network is provided by a second service provider; and
a processor that can configure automatic reroute of a communication session for the electronic device from the mobile telephone network to the IP-based wireless communication network such that new communication sessions established in the mobile telephone network that are for termination at the electronic device will be automatically routed to the IP-based wireless communication network.

10. The electronic device as recited in claim 9 further comprising a transceiver for detecting at least one of the mobile telephone network and the IP-based wireless communication network.

11. The electronic device as recited in claim 9 further comprising a display for indicating to the electronic device when at least one of the mobile telephone network and the IP-based wireless communication network is detected.

12. The electronic device of claim 9, wherein the first modem activates when at least one of the IP-based wireless communication network is substantially inaccessible and the mobile telephone network is detected.

13. The electronic device of claim 9, wherein the first modem deactivates when the IP-based wireless communication network is detected.

14. The electronic device of claim 9, wherein the second modem activates when the IP-based wireless communication network is detected.

15. The electronic device of claim 9, wherein the second modem deactivates when the IP-based wireless communication network is substantially inaccessible.

16. The electronic device of claim 9, wherein the second modem remains activated until a preceding communication session remains established in the IP-based wireless communication network.

17. A computer program product for use with a computer, the computer program product comprising a computer usable medium having a computer readable program code embodied therein, for managing one or more communication sessions in a plurality of networks, the plurality of networks comprising one or more mobile telephone networks and one or more IP-based wireless communication networks, the computer program code performing:
accessing a mobile telephone network of the one or more mobile telephone networks by an electronic device, wherein service from the mobile telephone network is provided by a first service provider;
detecting an IP-based wireless communication network of the one or more IP-based wireless communication networks by the electronic device, wherein service from the IP-based wireless communication network is provided by a second service provider; and
automatically establishing a rerouting of communication sessions for the electronic device from the mobile telephone network to the IP-based wireless communication network such that new communication sessions established on the mobile telephone network that are for termination at the electronic device will be automatically routed to the IP-based wireless communication network.

18. The computer program product of claim 17, wherein the computer program code further performs:
presenting a user indication by the electronic device after the IP-based wireless communication network is detected.

19. The computer program product of claim 17, wherein the computer program code further performs:
assigning an identifier to the electronic device when the mobile telephone network is accessed by the electronic device, wherein the identifier enables the mobile telephone network to identify the electronic device.
